(19) United States
(12) Patent Application Publication
(10) Pub. No.: US 2004/0034622 A1
(43) Pub. Date: Feb. 19, 2004

(54) Applications software and method for authoring and communicating multimedia content in a multimedia object communication and handling platform

(76) Inventors: Danny Javier Espinoza, Washington, DC (US); Craig Krantz, Ojai, CA (US); Robert M. Yarmey, Crozet, VA (US)

Correspondence Address: SCHWARTZ LAW FIRM, P.C., 6100 FAIRVIEW ROAD, SUITE 530, CHARLOTTE, NC, 28210, US

(21) Appl. No.: 10/639,699

(22) Filed: Aug. 12, 2003

Related U.S. Application Data
(60) Provisional application No. 60/403,079, filed on Aug. 13, 2002.

(51) Int. Cl. G06F 7/00

(52) U.S. Cl. 707/1

(57) ABSTRACT

An applications software and method for authoring and communicating multimedia content in a multimedia object communication and handling platform. The applications software includes a Document Type Definition (DTD) and an Extensible Markup Language (XML) document created according to the DTD. The XML document describes multimedia content and the behavior of the content in a dynamic multimedia communication. A player is adapted for reading the DTD and processing the XML document for playback of the content within the multimedia object communication and handling platform.

### TECHNICAL FIELD AND BACKGROUND OF THE INVENTION

This invention relates to an applications software and method for authoring and communicating multimedia content in a multimedia object communication and handling platform. The invention comprises a software platform that simplifies the process of creating multimedia authoring and playback applications. The platform is built on an open XML file format and is powered by a media engine, featuring a complete set of media content translation and handling tools in its core libraries. Several authoring interfaces offer ATM-like simplicity for compiling rich multimedia presentations, movies, media albums, etc., and can be extended to different applications.

Using XML for the core file format allows the invention's unique player technology to be driven externally using any widely available XML tool rather than a complicated API. Any source of data capable of outputting XML can present that data as a full featured multimedia presentation. While this opens the Player to third party authoring environments, a particularly significant implication of this access is dynamic presentation creation.

Dynamically created XML is much more common than static XML documents for most uses other than templates. Using existing tools and standards like XSLT, an XML transformation standard, multimedia presentations can be created “on the fly.” For example, most database managers can now output the results of queries as XML. By processing that output and stored templates via XSLT a custom presentation can be created based on/user input. That query may have been a search for houses for sale based on user criteria, or a search for a set of randomly selected test questions at a specified difficulty level. The new presentation can collect user responses and send them back to the server to be used to create the next query. This is especially useful for interactive user-directed searches for program training and certification testing.

The media player technology powered by the present framework can be deployed in a variety of ways, such as a desktop application, as a thin-client, on a set-top box, or as a web browser plug-in. The authoring environment can either be deployed as a desktop application, as a web application or a site that generates suitable XML code accessible to the present framework. Content can be stored remotely and played locally, or vice versa. One particularly attractive feature of the present framework in a network setting is its ability to playback content that is stored remotely without caching this content locally. This can save bandwidth and storage costs as well as provide for the protection of secured digital assets.

Additional functionality can be added to the framework. For external functions like rights management, database integration and others, either simple plug-ins created by Applicant or by the customer or various XML settings can modify what happens to media objects before or after they enter the present platform. For internal functionality like animation settings, graphic filters and such, APIs can be provided to incorporate advanced settings within the platform's multimedia world.

### SUMMARY OF INVENTION

Therefore, it is an object of the invention to provide a multimedia object communication and handling platform which enables creation of full-featured multimedia authoring and playback applications in a wide range of environments.

It is another object of the invention to provide a multimedia object communication and handling platform which can both read and write XML. Thus, since all functions of the invention can be described in XML, most data types can be brought into, or passed out of, the present platform.

It is another object of the invention to provide a multimedia object communication and handling platform which developers can use as a “black box” application with XML as the API.

It is another object of the invention to provide a multimedia object communication and handling platform which enables a platform application to include protected information (e.g., from an electronic textbook) without compromising copyrights.

It is another object of the invention to provide a multimedia object communication and handling platform which may be used to execute applications with dynamic data.

It is another object of the invention to provide a multimedia object communication and handling platform wherein databases can be accessed and/or updated during the execution of platform applications.

It is another object of the invention to provide a multimedia object communication and handling platform wherein output from platform applications can be transferred as XML documents, consuming very little space or bandwidth.

It is another object of the invention to provide a multimedia object communication and handling platform which offers HTTP object linking capabilities; dynamic incorporation of external content sources.

It is another object of the invention to provide a multimedia object communication and handling platform which offers an ATM-style, pushbutton authoring interface.

It is another object of the invention to provide a multimedia object communication and handling platform which provides support for capture and/or playback of live video.

It is another object of the invention to provide a multimedia object communication and handling platform which includes built-in video, image, audio and text editing tools.

It is another object of the invention to provide a multimedia object communication and handling platform which offers an import/edit facility for Powerpoint™ and Hyperstudio™ presentations.

It is another object of the invention to provide a multimedia object communication and handling platform which utilizes media engine objects in a C++ framework, the objects being full implementations that control the display and user interaction with various types of media.

It is another object of the invention to provide a multimedia object communication and handling platform which utilizes a C++ framework that developers can use to present interactive multimedia in a window.

It is another object of the invention to provide a multimedia object communication and handling platform including media engine objects which may specify a hyperlink to launch a document or application, or to open the user's preferred web browser to a specific site.

It is another object of the invention to provide a multimedia object communication and handling platform including media engine objects which can incorporate web content internally without launching a browser through built-in HTTP capabilities. This powerful feature allows application-specific or web content to be part of every media engine presentation.

It is another object of the invention to provide a multimedia object communication and handling platform wherein navigation in the media engine presentation is provided by handling slide clicks, or hyperlinks that may be embedded in text.

It is another object of the invention to provide a multimedia object communication and handling platform including a media engine which supports an “invisible linking” object which can be used to make areas of each slide “clickable.” This object can also be used to override the default interaction with objects (for example, a playing movie can be covered by a clickable area that launches to a web site, jumps to another slide, launches an application, or plays audio/video clips). Furthermore, these objects can be used to record and respond to user input.

It is another object of the invention to provide a multimedia object communication and handling platform which includes media engine frameworks that support the exportation and playback of content with the appropriate XML tags. All exported objects and media engine actions (slides, animations, timings, etc.) can thus be accessed by other applications capable of reading XML. Likewise, objects from other applications that have the appropriate XML tags can be read and played back by an XML-compatible instance of the media engine.

It is another object of the invention to provide a multimedia object communication and handling platform which includes media engine frameworks that provide a complete, cross-platform code base to assemble interactive multimedia presentations. The default media objects support navigation, text, images and video, in addition to URL-based image and video content. Furthermore, the media engine frameworks can be extended to handle even more complex objects and animation. C++ developers, using the present media engine, can create rich multimedia environments easily.

These and other objects of the present invention are achieved in the preferred embodiments disclosed below by providing an applications software for authoring and communicating multimedia content in a multimedia object communication and handling platform. The applications software includes a Document Type Definition (DTD) and an Extensible Markup Language (XML) document created according to the DTD. The XML document describes multimedia content and the behavior of the content in a dynamic multimedia communication. A player is adapted for reading the DTD and processing the XML document for playback of the content within the multimedia object communication and handling platform.

According to another preferred embodiment, the invention is a method of creating an applications software for authoring and communicating multimedia content in a multimedia object communication and handling platform. The method includes the steps of establishing a Document Type Definition (DTD). An Extensible Markup Language (XML) document is then created according to the DTD. The XML document describes multimedia content and the behavior of the content in a dynamic multimedia communication. A player then reads the DTD and processes the XML document for playback of the content within the multimedia object communication and handling platform.

### DESCRIPTION OF THE PREFERRED EMBODIMENT AND BEST MODE

A multimedia object communication and handling platform (hereinafter “MOCHa” or “Platform”) according to the present invention is described below. The Platform offers a set of software tools, resources and specifications that allow developers and non-programming users to add rich multimedia authoring or player capabilities to communications-oriented applications. These applications provide users with the means of creating and communicating multimedia content to one or more consumers of that content. This may include, for example, e-learning or instructional content applications, interactive web services applications, and others.

Technology Description

In one preferred embodiment, the Platform includes the following three components: a Media Engine, a Data Engine, and a Translation Engine.

The Media Engine lies at the core of a C++ framework (“Framework”) that handles the playback of multimedia content within the Platform environment. The Media Engine implements a number of classes that define the elements of an interactive, dynamic slide show presentation. The core classes include the media engine class (which manages all aspects of the presentation), a slide class (which is also a container class), a media object class, an event class (for scripting of media objects), a reveal class (for slide transitions), a transition class (for media object transitions) and a timer class.

Features of the Media Engine include:

Support for QuickTime (images, video, VR, MP3, animated GIF, streaming video, etc.)

Support for scrolling text fields with hyperlinks

Small memory footprint (approximately 800K)

Cross-platform (Macintosh and Windows) code and native file format

Extensible classes (media objects, slide transitions and object transitions)

Plug-in architecture for source and sink bindings

Handles live video, simultaneous playback of multiple video sources, streaming video, etc.

Plays multiple audio tracks and audio behind multiple slides

Enables time synchronization of objects and events

The Data and Translation Engines are two smaller class libraries which implement data retrieval and importing/translation, respectively. The Data Engine is a small abstract class that executes methods for reading bytes from a data stream. The core class includes methods for opening a stream, closing a stream, getting the size of a stream and getting and setting the position of a marker in the stream. The default implementation of this class is written to support a file stream. The Translation Engine is a small abstract class that executes methods for translating a data stream (which is driven by a Data Engine object) into a hierarchy of Media Engine objects known as a multimedia world.

These three libraries, the Media Engine, Translation Engine and Data Engine, are easily extended to add new functionality, allowing the present Framework to act as the core of any interactive multimedia code inside an application that requires these services. With the addition of an XML file format, this Framework has been modified to operate without reading in a binary file, enabling the assembly and playback of multimedia content “on the fly.” Indeed, any environment, process or application capable of writing XML according to the Platform specification can have the resulting content played back by the present multimedia engine.

Development Process

Typical usage of the present technology includes the creation of Platform XML files describing multimedia content (text, images, shapes, audio, video, charts) and behavior (movement, interactivity, behavior tracking), either dynamically by a computerized process, or more traditionally through a desktop or web application. The resulting XML file(s) then activate the multimedia Framework for rendering on screen. The Framework can exist as components of another application or environment, or as Applicant's own Player application. The Player application can be distributed as a stand alone client application, or can function as a Web Browser plug-in.

Developers can also create custom external processes that can control and pass data into and out of a content “package” being rendered by the Framework.

The Platform Document Type Definition (DTD) is as follows:

-->
<!ENTITY % object_types “(textobj | graphicobj | chartobj | audioobj |
videoobj | hotbuttonobj | scrolltextobj | imageobj | liveaudioobj | livevideoobj
)”>
<!ENTITY % object_type_numbers “(200 | 201 | 202 | 203 | 204 | 205 | 208 | 209
| 210 | 211)”>
<!--.
Object type numbers and names in the lists above map directly. Graphics objects
(type 201) are custom graphics only. The new type, 209, is image (file) object.
-->
<!--.-->
<!ENTITY % slide_click_types ”( 0 | 1 | 2 | 3 | 4 )” >
<!--.

slide_click_types values see “Individual action types ” below

-->
<!ENTITY % slide_transition_sub_types “(0 | 1 | 2 | 3| 4 | 5 | 6 | 7 ) ” >
<!--.

Values are index into selector buttons array for each type

-->
<!ENTITY % slide_transition_types “( 0 | 1 | 2 | 3 | 4 )” >
<!--.

no transition = 0
mmRevealSweep = 1,
mmRevealDoors = 2,
mmRevealBlinds = 3,
mmRevealOther = 4

-->
<!--.-->
<!ENTITY % object_event_types “( 1 | 2 | 3 )” >
<!--.

Enters = 1,
Exits = 2,
Plays = 3

-->
<!ENTITY % object_event_transitions “( 0 | 1 | 2 | 3 | 4 | 5 | 6 | 7 | 8 | 9 |
10 | 11 )” >
<!--.

mmTransNone = 0,
mmTransSlideN = 1,
mmTransSlideNE = 2,
mmTransSlideE = 3,
mmTransSlideSE = 4,
mmTransSlideS = 5,
mmTransSlideSW = 6,
mmTransSlideW = 7,
mmTransSlideNW = 8,
mmTransFade = 9,
mmTransPixelFine = 10,
mmTransPixelCoarse = 11
// For play events
mmPlayInBackground = 0
mmPlayInForeground = 1

-->
<!--.-->
<!ENTITY % cust_graphic_types “( 1 | 2 | 3 | 4 | 5 | 6 | 7 | 14 )” >
<!--.

1 solid rectangle
2 solid round rectangle
3 solid oval
4 line with positive slope (bottom-left to top-right)
5 hollow rectangle
6 hollow round rectangle
7 hollow oval
14 line with negative slope (top-left to bottom-right)

-->
<!ENTITY % cust_graphic_thickness “( 2 | 4 | 6 | 8 | 10 | 12 | 14 | 16 )” >
<!ENTITY % action_class “( defaultaction | launchaction | sendaction )” >
<!ENTITY % action_types “(0 | 1 | 2 | 3 | 4 | 5 | 6 | 7 | 8 | 9 )” >
<!--.

Individual action types :
mmActionNone = 0,
mmActionJumpNext = 1,
mmActionJumpPrevious = 2,
mmActionJumpTo = 3,
mmActionJumpBack = 4,
mmActionLaunch = 5,
mmActionPlay = 6,
mmActionJumpURL = 7,
mmActionJumpPlayer = 8,
// send to plugin
mmActionSend = 9
Action class groups:
defaultaction = 0 - 4, 6
sendaction = 9
launchaction = 5, 7, 8

-->
<!ENTITY % image_source “(0 | 1 | 2 | 3 | 4)” >
<!--.

embedded = 0,
reference,
url,
plugin,
rgb

-->
<!ENTITY % movie_stop_action “(0 | 1 | 2 )” >
<!--.

0 jump back to beginning
1 stay where stopped
2 jump to end

-->
<!ENTITY % loop_type “(0 | 1 | 2 )” >
<!--.

0 == no loop
1 == continuous loop
2 == palindrome

-->
<!--.

AutoScroll values

-->
<!ENTITY % autonone “0” >
<!ENTITY % autocreditsroll “1” >
<!ENTITY % autotickersroll “2” >
>!ENTITY % autoscrolltype “(%autonone; | %autocreditsroll; | %autotickersroll;)”
>
<!--.

fileref path object types

-->
<!ENTITY % pc_path_type “1” >
<!ENTITY % unix_path_type “2” >
<!ENTITY % fsspec_path_type “3” >
<!ENTITY % generic_path_type “4” >
<!ENTITY % path_type “(%pc_path_type; | %unix_path_type; | %fsspec_path_type; |
%generic_path_type;)” >
<!ENTITY % true “1” >
<!ENTITY % false “0” >
<!ENTITY % boolean “( %true; | %false; )” >
<!ELEMENT MOCHaXML (presentation) >
<!ATTLIST MOCHaXML

version %dtd_versions; #REQUIRED>

<!ELEMENT presentation (slide*, serialcounter?) >
<!--

origin - platform of origin
dtd_version - In the future we may allow aggregating presentations

built to different versions of the DTD. This is the
DTD version the pres was built to.

pres_version - The pres version changes when the meaning of data in

the presentation changes. The dtd format version may remain
the same, e.g., if the font size is written unadjusted in
0.1.0, and we start to write an adjusted font size, the dtd
version would not change but the pres_version would
increment.

YExtent - Y Extent of original presentation
XExtent - X Extent of original presentation

-->
<!ATTLIST presentation

```
  dtd_version %dtd_versions; #REQUIRED
  pres_version (0.1.0) “0.1.0”
  origin (mac | pc) “pc”
  xextent CDATA “640”
  yextent CDATA “480”
  slidecount CDATA #REQUIRED >
```

<!--

imageobj is the background image for the slide
slidetime is in milliseconds. A value of −1 means on click

-->
< ! E L E M E N T s l i d e
(imageobj, transition, objevents, slideobject*, name?, speakernotes?, serialcounter?)
>
<!ATTLIST slide

uniqueid CDATA #REQUIRED
objectcount CDATA #REQUIRED
clicktype %slide_click_types; “1”
clickjump CDATA “0”
slidetime CDATA “−1” >

<!ELEMENT transition EMPTY >
<!ATTLIST transition

type %slide_transition_sub_types; “0”
trans %slide_transition_types; “0” >

<!ELEMENT slideobject (objevents, %object_types;, name?, hotbuttonobj?) >
<!ATTLIST slideobject

objid CDATA #REQUIRED
top CDATA #REQUIRED
left CDATA #REQUIRED
height CDATA #REQUIRED
width CDATA #REQUIRED
objtype %object_type_numbers; #REQUIRED >

<!--.

Slide objects must have an objevents element, but that may be empty.
Only events that occur between slide enters and slide exits NEED be
written to file, although all events CAN be written for all slide
objects. This would be usefull for authoring environments that
use the xmp as their persistent storage.

-->
<!ELEMENT objevents (entersevent?, exitsevent?, playsevent?) >
<!ELEMENT entersevent (objevent) >
<!ELEMENT exitsevent (objevent) >
<!ELEMENT playsevent (objevent) >
<!--.

time: event time in milliseconds
speed: 0 = slow, 1 = medium, 2 = fast
For plays events, transition value flags background/forerground
play. See object_event_transitions entity definition.

-->
<!ELEMENT objevent EMPTY >
<!ATTLIST objevent

index CDATA #REQUIRED
type %object_event_types; #REQUIRED
time CDATA #REQUIRED
transition %object_event_transitions; “0”
speed (0 | 1 | 2 ) “2”>

<!--.

color is the background color for the text box. It must alway be set to
a known value with white (255, 255, 255) being the acceptable default.
If the “fillbkg” attribute is true the background color is used as fill,
otherwise the text is rendered transparent and the fillcolor it used for
anti-aliasing the text. In the anti-aliasing case, the value should be
the average color value of the background under text area.
Justification values
left = 0, center = 1, right = −1
scrollspeed values
slow = 0, medium = 1, fast = 2

-->
<!ELEMENT textobj (color, styleruns, hyperlinks?) >
<!ATTLIST textobj

isbullet %boolean; “0”
justification (0 | 1 | −1) “0”
fillbkg %boolean; “0”
autoscroll %autoscrolltype; “0”
scrollspeed (0 | 1 | 2) “0”
bulletchar CDATA #IMPLIED
speechname CDATA #IMPLIED

>
<!ELEMENT styleruns (stylerun+) >
<!--.

Stylerun is a block of text with homogeneous textstyle and color
attributes. It is not illegal by definition for two adjacent style runs
to have the same textstyle and color attributes.

-->
<!ELEMENT stylerun (textstyle, color, textdata ) >
<!ELEMENT textstyle EMPTY >
<!ATTLIST textstyle

font CDATA #REQUIRED
size CDATA #REQUIRED
face CDATA #REQUIRED
>

<!ELEMENT hyperlinks (hyperlink+) >
<!ELEMENT hyperlink (hotbuttonobj) >
<!ATTLIST hyperlink

| | | |
|---|---|---|
| linkoffset | CDATA | #REQUIRED |
| linklength | CDATA | #REQUIRED |
| > | | |

<!--.

firstpoint is which end of a line is the firstpoint, or beginning,
of the line. This is where the arrow is drawn for lines with arrows
at the beginning.
firstpoint 0 == left, 1 == right

-->
<!ELEMENT graphicobj (color) >
<!ATTLIST graphicobj

| type %cust_graphic_types; “1” | |
|---|---|
| thickness %cust_graphic_thickness; “4” | |
| arrows (0 \| 1 \| 2 \| 3) | “0” |
| firstpoint (0 \| 1) | “0” |
| > | |

<!ELEMENT imageobj (url | fileref | plugin | color) >
<!ATTLIST imageobj

source %image_source; #REQUIRED >

<!--.

The X axis and Y axis labels can be empty strings. Only those cells
that have data should be represented in the chartentry list.
color is the background fill color for the whole chart, or the
value to use for anti-aliasing the labels depending on the state
of fillbkg. See textobj for details on fill color.
chart types:
scatter = 0, line = 1, column = 2, bar = 3, pie = 4

-->
<!ELEMENT chartobj (color, xlabel, ylabel , chartentry+) >
<!ATTLIST chartobj

charttype (0 | 1 | 2 | 3 | 4) #REQUIRED
haslegend %boolean; #REQUIRED
hasvalues %boolean; #REQUIRED
fillbkg %boolean; “0”
>

<!ELEMENT chartentry EMPTY>
<!ATTLIST chartentry

cellrow CDATA #REQUIRED
cellcolumn CDATA #REQUIRED
cellvalue CDATA #REQUIRED >

<!ELEMENT audioobj (url | fileref | plugin) >
<!ATTLIST audioobj

| picture CDATA #IMPLIED | |
|---|---|
| source %image_source; #REQUIRED | |
| fadeup | CDATA #IMPLIED |
| fadedown | CDATA #IMPLIED |

| | |
|---|---|
| hascontroller | %boolean; #REQUIRED |
| audiolooptype | %loop_type; #REQUIRED |
| > | |

<!ELEMENT liveaudioobj EMPTY >
<!ATTLIST liveaudioobj

channelname CDATA #REQUIRED
starttimecode CDATA #REQUIRED
endtimecode CDATA #REQUIRED
>

<!ELEMENT videoobj (url | fileref | plugin) >
<!ATTLIST videoobj

| picture | CDATA #IMPLIED |
|---|---|
| source %image_source; #REQUIRED | |
| hascontroller | %boolean; #REQUIRED |

stopaction %movie_stop_action; #REQUIRED
videolooptype %loop_type; #REQUIRED
>

<!--.

channelname == Video capture information to use.
audiochannelname == Audio capture information to use.
This may also be “none” or empty (“”). This should be empty
for files written on the Mac
For Windows, channelname and audiochannelname are DirectShow
filter names.
The following truth table is for Windows only and describes
the audio source selected for rendering. 1394 is the
“Microsoft DV Camera and VCR” DirtectShow filter. Other is
any other filter name.

| channelname | audiochannel | audio source |
|---|---|---|
| 1394 | none | none |
| 1394 | “” | 1394 A/V interleave |
| 1394 | other | source specified |
| other | none | none |
| other | “” | none |
| other | other | source specified |

-->
<!ELEMENT livevideoobj EMPTY >
<!ATTLIST livevideoobj

channelname CDATA #REQUIRED
audiochannelname CDATA “”
>

<!ELEMENT hotbuttonobj (%action_class;, hotbuttonobj?) >
<!ATTLIST hotbuttonobj

| | |
|---|---|
| actiontype | %action_types; #REQUIRED |
| runclose | %boolean; “0”> |

<!ELEMENT defaultaction EMPTY >
<!ATTLIST defaultaction

actionindex CDATA #REQUIRED >

<!ELEMENT launchaction (url | fileref) >
<!ATTLIST launchaction

slidenum CDATA “0”
>

<!ELEMENT sendaction (plugin) >
<!ELEMENT plugin (magiccookie, userdata?) >
<!--.

objectid == ID of object that contains data to be sent to
data sink - for text imput field for example

-->
<!ATTLIST plugin

| | | |
|---|---|---|
| providerid | CDATA | #REQUIRED |

| | |
|---|---|
| version | CDATA #REQUIRED |

| | | |
|---|---|---|
| mediatype | CDATA | #REQUIRED |

objectid CDATA #IMPLIED
>

<!--.

fileref is a cross platform file reference. The base filename
and the associated path information are kept separately. Path
information can be kept in a number of system dependent formats.
One fileref can contain path information in multiple formats so
that the client can pick one it understands. The path
information is guaranteed not to contain illegal characters on
the target platform. If there is no path information the client
understands, it will look in the well defined search locations
for the base filename. If the base filename contains illegal
characters on a particular system, that file will be unsearchable.

-->
<!ELEMENT fileref (filename, path?) >
<!--

All of the child nodes of path have a pathobjtype attribute
used to quickly identify the type of the element

-->
<!ELEMENT path (( pcpath | unixpath | fsspec | genericpath )+) >
<!ELEMENT color EMPTY >
<!ATTLIST color

red CDATA “0”
green CDATA “0”
blue CDATA “0”>

<!--.

A persistent counter for authoring use in tracking
the next serial number to assign to child objects

-->
<!ELEMENT serialcounter EMPTY >
<!ATTLIST serialcounter

serialvalue CDATA #REQUIRED
>

<!--.
======================================================
These are leaf nodes that contain text data that may
have been entered by the user. Since the user may enter
characters that are illegal in parsed text, the data
in these entities should always be contained in
<! [CDATA [ ]]> sections
======================================================
-->
<!ELEMENT textdata (#PCDATA) >
<!ELEMENT userdata (#PCDATA) >
<!ELEMENT magiccookie (#PCDATA) >
<!ELEMENT xlabel (#PCDATA) >
<!ELEMENT ylabel (#PCDATA) >
<!ELEMENT speakernotes (#PCDATA) >
<!ELEMENT name (#PCDATA) >
<!ELEMENT filename (#PCDATA) >
<!ELEMENT url (#PCDATA) >
<!ELEMENT pcpath (#PCDATA) >
<!ATTLIST pcpath

pathobjtype %path_type; #REQUIRED
>

<!ELEMENT unixpath (#PCDATA) >
<!ATTLIST unixpath

pathobjtype %path_type; #REQUIRED
>

<!--.

Mac FSSpec for path specifaction

-->
<!ELEMENT fsspec (#PCDATA) >
<!ATTLIST fsspec

pathobjtype %path_type; #REQUIRED
volid CDATA #REQUIRED
dirid CDATA #REQUIRED
>

<!--.

For path information in formats we have not specified

-->
<!ELEMENT genericpath (#PCDATA) >
<!ATTLIST genericpath

| pathobjtype %path_type; #REQUIRED | | |
|---|---|---|
| pathtype | CDATA | #REQUIRED |
| pathversion | CDATA | #IMPLIED |
| > | | |

An XML document created according to the above specified DTD can then be opened by the Player application which processes it and renders the results as an on-screen multimedia presentation, complete with animation, transitions and timing. As previously indicated, the core of the Player is the Media Engine (or “MME”, as referenced below) that handles the playback of multimedia content within the Platform environment.

Playback Implementation

The code setup required to present an interactive multimedia world to the user generally follows these steps:

(a) Create an instance of the Media Engine and attach it to a window. This step creates the required off-screen buffers.

(b) Create an instance of the Data Engine and attach it to a file. This step opens the file.

(c) Create an instance of the Translation Engine and forward to it the instances of the Data Engine and Media Engine.

(d) Tell the Translation Engine to translate the file into a multimedia world. This step results in sequential reading and translating of the data. Corresponding Media Engine objects are instantiated.

(e) Tell the Media Engine to present the multimedia world.

After this point, the Media Engine is in control, handling user events, slide navigation, object transitions and object interaction. The Media Engine keeps image data in off-screen memory. If a low memory condition occurs, image data (which has not recently been in use) is purged. When the user has indicated that the presentation should end, the Media Engine can be disposed, which will also dispose of all Media Engine objects, the Data Engine, and the Translation Engine.

The Media Engine uses a dynamic, non-linear slide show presentation style. The presentation as a whole is divided into slides. Each slide, when shown, follows a script of events which define the order in which objects on the slide are to be displayed, and whether a transition should be applied when the object “enters” view. After this initial stream of events, the user is given control. If the user clicks on the slide or a hyperlink, the next slide that is to be displayed may be any other slide in the presentation. Slide navigation can also be set to go to the previous slide, the next slide, or the last slide shown. This type of navigation (from one slide to another) defines a typical multimedia presentation according to the present Platform. For example, a slide may contain a title, a number of images, and a QuickTime movie. Upon showing the slide, the script of events can specify that the title is to slide down into view, followed by each image, which dissolves or fades into place. Finally, the script can specify that the movie start playing. Upon reaching the end of the script, the user is now allowed to interact with the slide, either stopping (or interacting with) the movie or clicking through to the next slide.

In one preferred embodiment, the Media Engine (MME) process is as follows:

Main MME Program Loop

StartMME
StartSlide
UpdateSlide
WaitSlide
<GetSlideStatus>

if “slide is finished” then

EndSlide
<GetNextSlideNumber>
if −1 then

ShutdownMME

else

goto StartSlide

done

else

goto UpdateSlide

done

StartMME

AllocateMMEMemory
HideMenuBar
OpenWindow
OpenAndReadFile (parse XML file)

ShutdownMME

CloseWindow
ShowMenuBar
FreeMMEMemory

StartSlide

AllocateSlideMemory
OpenAllObjectsOnSlide
DrawBackgroundIntoBuffer
OpenEventList
HandleEvent

<GetNextEventNumber>
if −1 then

continue

else

goto HandleEvent

done

CloseEventList

UpdateSlide

UpdateAllObjectsThatAreVisibie
UpdateBackgroundAudioTrack

WaitSlide

CheckMousePosition
UpdateMouseCursor
CheckMouseClick
CheckKeyboard
UpdateWindow

EndSlide

CloseAllObjectsOnSlide
DetermineNextSlideNumber
FreeSlideMemory

HandleEvent

<GetEventType>

if “enter” then

ObjectEnter

else if “exit” then

ObjectExit

else if “play” then

ObjectPlay

done

The Media Engine described above exists internally within Applicant's commercial products, and may be incorporated separately by third parties into other application environments for multimedia processing.

The embodiments of the invention can be implemented through computer program code operating on one or more programmable computer systems or instruction execution systems such as a personal computers or workstation, or other microprocessor-based platforms. Such a system typically includes a system bus interconnecting the major components. The system is controlled by a microprocessor, which serves as the central processing unit (CPU) for the system. A system memory is typically divided into multiple types of memory or memory areas such as read-only memory (ROM), random-access memory (RAM) and others. A plurality of general input/output (I/O) adapters or devices are present. When the system is operating, computer program instructions are at least partially loaded into memory and executed by the microprocessor. One of the I/O devices is a network adapter or modem for connection to network, which may be the Internet, which may be a source or destination for streaming media related to the present invention.

Elements of the invention may be embodied in hardware and/or software as a computer program code (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system such as described above. A computer-usable or computer-readable medium may be any medium that can contain, store, communicate, or transport the program for use by or in connection with an instruction execution system. The computer-usable or computer-readable medium, for example, an electronic, magnetic, optical, electromagnetic, infrared, or semiconductor system. The medium may also be simply a stream of information being retrieved when the computer program product is “downloaded” through a network such as the Internet. Note that the computer-usable or computer-readable medium could even be paper or another suitable medium upon which a program is printed.

A multimedia object communication and handling platform is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

We claim:

1. An applications software for authoring and communicating multimedia content in a multimedia object communication and handling platform, said applications software comprising:
(a) a Document Type Definition (DTD);
(b) an Extensible Markup Language (XML) document created according to said DTD, and describing multimedia content and the behavior of said content in a dynamic multimedia communication; and
(c) a player adapted for reading said DTD and processing said XML document for playback of said content within the multimedia object communication and handling platform.

2. A method of creating an applications software for authoring and communicating multimedia content in a multimedia object communication and handling platform, said method comprising the steps of:
(a) establishing a Document Type Definition (DTD);
(b) creating an Extensible Markup Language (XML) document according to the DTD, the XML document describing multimedia content and the behavior of the content in a dynamic multimedia communication; and
(c) providing a player adapted for reading the DTD and processing the XML document for playback of the content within the multimedia object communication and handling platform.
